(19) United States
(12) Patent Application Publication
(10) Pub. No.: US 2022/0100112 A1
(43) Pub. Date: Mar. 31, 2022

(54) PHOSPHORESCENT TONERS AND RELATED METHODS

(71) Applicant: Xerox Corporation, Norwalk, CT (US)

(72) Inventors: Alexander Knowles, Rochester, NY (US); Yu Qi, Penfield, NY (US)

(21) Appl. No.: 17/036,017

(22) Filed: Sep. 29, 2020

(51) Int. Cl. G03G 9/08; G03G 9/09; G03G 9/087

(52) U.S. Cl. CPC G03G 9/081; G03G 9/0819; G03G 9/0827; G03G 9/0926; G03G 9/08728; G03G 9/0902

(57) ABSTRACT

Methods of making phosphorescent toner are provided. In an embodiment, such a method comprises forming a phosphorescent pigment emulsion comprising a phosphorescent pigment and a surfactant; homogenizing a mixture comprising a resin emulsion comprising a resin and the phosphorescent pigment emulsion; aggregating the mixture to form toner particles comprising the phosphorescent pigment embedded within and surrounded by the resin; and coalescing the toner particles to form a phosphorescent toner comprising the toner particles. The phosphorescent toners are also provided.

### BACKGROUND

Phosphorescence is a type of photoluminescence related to fluorescence, but which occurs on a slower time scale. Absorbed radiation is re-emitted from phosphorescent materials at lower intensities for extended periods of time, e.g., minutes to hours after the initial illumination. Phosphorescent pigment particles have been developed, but they tend to be relatively large since brightness scales with size. It has been challenging to incorporate phosphorescent pigment particles into toner particles with characteristics suitable for xerographic printing.

### SUMMARY

The present disclosure provides phosphorescent toners, methods of making the toners, and methods of using the toners.

Methods of making phosphorescent toner are provided. In an embodiment, such a method comprises forming a phosphorescent pigment emulsion comprising a phosphorescent pigment and a surfactant; homogenizing a mixture comprising a resin emulsion comprising a resin and the phosphorescent pigment emulsion; aggregating the mixture to form toner particles comprising the phosphorescent pigment embedded within and surrounded by the resin; and coalescing the toner particles to form a phosphorescent toner comprising the toner particles.

Phosphorescent toners are also provided. In an embodiment, such a toner comprises toner particles comprising a core comprising a phosphorescent pigment embedded within and surrounded by a resin. The toner particles may have a volume average particle size of 5.0 μm to 10.0 μm, a volume average geometric size distribution (GSDv) of from 1.100 to 1.300, and a number average geometric size distribution (GSDn) of from 1.100 to 1.300.

### DETAILED DESCRIPTION

The present disclosure provides phosphorescent toners, methods of making the toners, and methods of using the toners.

The phosphorescent toners comprise phosphorescent pigments and polymeric resins. The phosphorescent pigment and polymeric resin may form a core of a toner particle in which the phosphorescent pigment is embedded within and surrounded by the polymeric resin. A shell may be formed over this core, the shell also comprising a polymeric resin, which may or may not be the same as the resin within the core. As noted above, although some phosphorescent toners have been developed, unlike other pigments, it is particularly challenging to incorporate phosphorescent pigment particles into polymeric resins. Such challenges have meant that phosphorescent toners are generally formed by methods other than emulsion aggregation (EA) methods, such as physical toner preparation processes (e.g., melt blending/mixing/kneading, extrusion, etc.). The present disclosure is based, at least in part, on the development of an improved EA toner preparation process that achieves phosphorescent toner particles having a shape, size and size distribution that makes them optimal for xerographic printing applications. Moreover, unlike physical toner preparation processes, the present EA toner preparation process allows for intimate incorporation of the phosphorescent pigment into the polymeric resin such that it is embedded within and surrounded by the polymeric resin.

Phosphorescent Pigment

The present toner particles comprise a phosphorescent pigment, generally within a core of the toner particle. In embodiments, phosphorescent pigment is a lanthanide doped alkaline earth metal aluminate, such as strontium aluminate doped with a lanthanide such as europium (Eu), dysprosium (Dy), and neodynmium (Nd). However, other phosphorescent pigments may be used such as copper doped zinc sulfide. Combinations of different types of phosphorescent pigments may be used in the toner. As used throughout the present disclosure, “toner particles” refers to the particles of a toner, while “toner” refers to the collection of toner particles.

The phosphorescent pigments themselves are generally in the form of particles. In embodiments, such particles have an average diameter in a range of from 2 μm to 10 μm, from 2 μm to 8 μm, from 5 μm to 10 μm, or 5 μm. The term “average” refers to an average value as measured from a collection of phosphorescent pigment particles used in forming the toner according to the present methods.

The phosphorescent pigments may be characterized by a brightness as quantified by an afterglow at 10 minutes and an afterglow at 60 minutes. In embodiments, the phosphorescent pigment has an afterglow at 10 minutes of at least 300 mcd/m², at least 250 mcd/m², at least 200 mcd/m², or in a range of from 200 mcd/m² to 300 mcd/m². In embodiments, the phosphorescent pigment has an afterglow at 60 minutes of at least 15 mcd/m², at least 20 mcd/m², at least 25 mcd/m², or in a range of from 15 mcd/m² to 25 mcd/m².

Generally, the toner particles have, on average, a single phosphorescent pigment particle therein. The term “average” refers to an average value as measured from a collection of toner particles (i.e., toner) formed according to the present methods. An average value of 1 phosphorescent pigment particle-per-toner particle demonstrates the effectiveness of the present methods in incorporating phosphorescent pigments as described above. By contrast, average values <1 indicates that some toner particles are “clear” or “white” having no phosphorescent pigment therein. The number of phosphorescent pigments-per-particle may be determined from scanning electron microscope (SEM) images.

The amount of phosphorescent pigment used in the present toners may vary. In embodiments, the phosphorescent pigment is present at an amount in the range of from 5 weight % to 30 weight % by weight of the toner, from 10 weight % to 25 weight % by weight of the toner, or from 10 weight % to 20 weight % by weight of the toner. If more than one type of phosphorescent pigment is used, these amounts refer to the total amount of phosphorescent pigment in the toner.

Resins

A variety of resins may be used to form the present toner particles, which provide a polymeric matrix to contain the phosphorescent pigments described above. Toner particles may comprise more than one different type of resin. The resin may be an amorphous resin, a crystalline resin, or a mixture of crystalline and amorphous resins. The resin may be a polyester resin, including an amorphous polyester resin, a crystalline polyester resin, or a mixture of crystalline polyester and amorphous polyester resins.

Crystalline Resin

The resin may be a crystalline polyester resin formed by reacting a diol with a diacid in the presence of an optional catalyst. For forming a crystalline polyester, suitable organic diols include aliphatic diols with from about 2 to about 36 carbon atoms, such as 1,2-ethanediol, 1,3-propanediol, 1,4-butanediol, 1,5-pentanediol, 2,2-dimethylpropane-1,3-diol, 1,6-hexanediol, 1,7-heptanediol, 1,8-octanediol, 1,9-nonanediol, 1,10-decanediol, 1,12-dodecanediol, combinations thereof, and the like including their structural isomers. The aliphatic diol may be, for example, selected in an amount of from about 40 to about 60 mole percent of the resin, from about 42 to about 55 mole percent of the resin, or from about 45 to about 53 mole percent of the resin, and a second diol may be selected in an amount of from about 0 to about 10 mole percent of the resin or from about 1 to about 4 mole percent of the resin.

Examples of organic diacids or diesters including vinyl diacids or vinyl diesters selected for the preparation of crystalline resins include oxalic acid, succinic acid, glutaric acid, adipic acid, suberic acid, azelaic acid, sebacic acid, fumaric acid, dimethyl fumarate, dimethyl itaconate, cis, 1,4-diacetoxy-2-butene, diethyl fumarate, diethyl maleate, phthalic acid, isophthalic acid, terephthalic acid, naphthalene-2,6-dicarboxylic acid, naphthalene-2,7-dicarboxylic acid, cyclohexane dicarboxylic acid, malonic acid and mesaconic acid, a diester or anhydride thereof. The organic diacid may be selected in an amount of, for example, from about 40 to about 60 mole percent of the resin, from about 42 to about 52 mole percent of the resin, or from about 45 to about 50 mole percent of the resin, and a second diacid can be selected in an amount of from about 0 to about 10 mole percent of the resin.

Polycondensation catalysts which may be utilized in forming crystalline (as well as amorphous) polyesters include tetraalkyl titanates, dialkyltin oxides such as dibutyltin oxide, tetraalkyltins such as dibutyltin dilaurate, and dialkyltin oxide hydroxides such as butyltin oxide hydroxide, aluminum alkoxides, alkyl zinc, dialkyl zinc, zinc oxide, stannous oxide, or combinations thereof. Such catalysts may be utilized in amounts of, for example, from about 0.01 mole percent to about 5 mole percent based on the starting diacid or diester used to generate the polyester resin.

Examples of crystalline resins include polyesters, polyamides, polyimides, polyolefins, polyethylene, polybutylene, polyisobutyrate, ethylene-propylene copolymers, ethylene-vinyl acetate copolymers, polypropylene, mixtures thereof, and the like. Specific crystalline resins may be polyester based, such as poly(ethylene-adipate), poly(propylene-adipate), poly(butylene-adipate), poly(pentylene-adipate), poly(hexylene-adipate), poly(octylene-adipate), poly(ethylene-succinate), poly(propylene-succinate), poly(butylene-succinate), poly(pentylene-succinate), poly(hexylene-succinate), poly(octylene-succinate), poly(ethylene-sebacate), poly(propylene-sebacate), poly(butylene-sebacate), poly(pentylene-sebacate), poly(hexylene-sebacate), poly(octylene-sebacate), poly(decylene-sebacate), poly(decylene-decanoate), poly(ethylene-decanoate), poly(ethylene dodecanoate), poly(nonylene-sebacate), poly(nonylene-decanoate), copoly(ethylene-fumarate)-copoly(ethylene-sebacate), copoly(ethylene-fumarate)-copoly(ethylene-decanoate), copoly(ethylene-fumarate)-copoly(ethylene-dodecanoate), copoly(2,2-dimethylpropane-1,3-diol-decanoate)-copoly(nonylene-decanoate), poly(octylene-adipate), and mixtures thereof. Examples of polyamides include poly(ethylene-adipamide), poly(propylene-adipamide), poly(butylenes-adipamide), poly(pentylene-adipamide), poly(hexylene-adipamide), poly(octylene-adipamide), poly(ethylene-succinimide), poly(propylene-sebecamide), and mixtures thereof. Examples of polyimides include poly(ethylene-adipimide), poly(propylene-adipimide), poly(butylene-adipimide), poly(pentylene-adipimide), poly(hexylene-adipimide), poly(octylene-adipimide), poly(ethylene-succinimide), poly(propylene-succinimide), poly(butylene-succinimide), and mixtures thereof.

In embodiments, the crystalline polyester resin has the following formula (I)

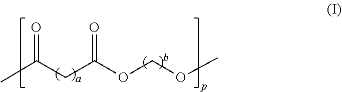

wherein each of a and b may range from 1 to 12, from 2 to 12, or from 4 to 12 and further wherein p may range from 10 to 100, from 20 to 80, or from 30 to 60. In embodiments, the crystalline polyester resin is poly(1,6-hexylene-1,12-dodecanoate), which may be generated by the reaction of dodecanedioc acid and 1,6-hexanediol.

As noted above, the disclosed crystalline polyester resins may be prepared by a polycondensation process by reacting suitable organic diols and suitable organic diacids in the presence of polycondensation catalysts. A stoichiometric equimolar ratio of organic diol and organic diacid may be utilized, however, in some instances where the boiling point of the organic diol is from about 180° C. to about 230° C., an excess amount of diol, such as ethylene glycol or propylene glycol, of from about 0.2 to 1 mole equivalent, can be utilized and removed during the polycondensation process by distillation. The amount of catalyst utilized may vary, and can be selected in amounts, such as for example, from about 0.01 to about 1 or from about 0.1 to about 0.75 mole percent of the crystalline polyester resin.

The crystalline resin may be present, for example, in an amount of from 1 weight % to 20 weight % by weight of the toner, from 5 weight % to 15 weight % by weight of the toner, or from 5 weight % to 10 weight % by weight of the toner.

The crystalline resin can possess various melting points of, for example, from about 30° C. to about 120° C., from about 50° C. to about 90° C., or from about 60° C. to about 80° C. The crystalline resin may have a number average molecular weight (Mₙ), as measured by gel permeation chromatography (GPC) of, for example, from about 1,000 to about 50,000, from about 2,000 to about 25,000, or from about 5,000 to about 20,000, and a weight average molecular weight (M_{w}) of, for example, from about 2,000 to about 100,000, from about 3,000 to about 80,000, or from about 10,000 to about 30,000, as determined by GPC. The molecular weight distribution (M_{w}/Mₙ) of the crystalline resin may be, for example, from about 2 to about 6, from about 3 to about 5, or from about 2 to about 4.

Amorphous Resin

The resin may be an amorphous polyester resin formed by reacting a diol with a diacid in the presence of an optional catalyst. Examples of diacids or diesters including vinyl diacids or vinyl diesters utilized for the preparation of amorphous polyesters include dicarboxylic acids or diesters such as terephthalic acid, phthalic acid, isophthalic acid, fumaric acid, trimellitic acid, dimethyl fumarate, dimethyl itaconate, cis, 1,4-diacetoxy-2-butene, diethyl fumarate, diethyl maleate, maleic acid, succinic acid, itaconic acid, succinic acid, succinic anhydride, dodecylsuccinic acid, dodecylsuccinic anhydride, glutaric acid, glutaric anhydride, adipic acid, pimelic acid, suberic acid, azelaic acid, dodecanediacid, dimethyl terephthalate, diethyl terephthalate, dimethylisophthalate, diethylisophthalate, dimethylphthalate, phthalic anhydride, diethylphthalate, dimethyl succinate, dimethylfumarate, dimethylmaleate, dimethylglutarate, dimethyladipate, dimethyl dodecylsuccinate, and combinations thereof. The organic diacids or diesters may be present, for example, in an amount from about 40 to about 60 mole percent of the resin, from about 42 to about 52 mole percent of the resin, or from about 45 to about 50 mole percent of the resin.

Examples of diols which may be utilized in generating an amorphous polyester include 1,2-propanediol, 1,3-propanediol, 1,2-butanediol, 1,3-butanediol, 1,4-butanediol, pentanediol, hexanediol, 2,2-dimethylpropanediol, 2,2,3-trimethylhexanediol, heptanediol, dodecanediol, bis(hydroxyethyl)-bisphenol A, bis(2-hydroxypropyl)-bisphenol A, 1,4-cyclohexanedimethanol, 1,3-cyclohexanedimethanol, xylenedimethanol, cyclohexanediol, diethylene glycol, bis(2-hydroxyethyl) oxide, dipropylene glycol, dibutylene, and combinations thereof. The amount of organic diols selected may vary, for example, the organic diols may be present in an amount from about 40 to about 60 mole percent of the resin, from about 42 to about 55 mole percent of the resin, or from about 45 to about 53 mole percent of the resin.

Examples of suitable amorphous resins include polyesters, polyamides, polyimides, polyolefins, polyethylene, polybutylene, polyisobutyrate, ethylene-propylene copolymers, ethylene-vinyl acetate copolymers, polypropylene, and the like, and mixtures thereof.

An unsaturated amorphous polyester resin may be utilized as a resin. Examples of such resins include those disclosed in U.S. Pat. No. 6,063,827, the disclosure of which is hereby incorporated by reference in its entirety. Exemplary unsaturated amorphous polyester resins include, but are not limited to, poly(propoxylated bisphenol co-fumarate), poly(ethoxylated bisphenol co-fumarate), poly(butyloxylated bisphenol co-fumarate), poly(co-propoxylated bisphenol co-ethoxylated bisphenol co-fumarate), poly(1,2-propylene fumarate), poly(propoxylated bisphenol co-maleate), poly(ethoxylated bisphenol co-maleate), poly(butyloxylated bisphenol co-maleate), poly(co-propoxylated bisphenol co-ethoxylated bisphenol co-maleate), poly(1,2-propylene maleate), poly(propoxylated bisphenol co-itaconate), poly(ethoxylated bisphenol co-itaconate), poly(butyloxylated bisphenol co-itaconate), poly(co-propoxylated bisphenol co-ethoxylated bisphenol co-itaconate), poly(1,2-propylene itaconate), and combinations thereof.

A suitable polyester resin may be an amorphous polyester such as a poly(propoxylated bisphenol A co-fumarate) resin. Examples of such resins and processes for their production include those disclosed in U.S. Pat. No. 6,063,827, the disclosure of which is hereby incorporated by reference in its entirety.

Suitable polyester resins include amorphous acidic polyester resins. An amorphous acid polyester resin may be based on any combination of propoxylated bisphenol A, ethoxylated bisphenol A, terephthalic acid, fumaric acid, and dodecenyl succinic anhydride, such as poly(propoxylated bisphenol-co-terephthlate-fumarate-dodecenylsuccinate). Another amorphous acid polyester resin which may be used is poly(propoxylated-ethoxylated bisphenol-co-terephthalate-dodecenylsuccinate-trimellitic anhydride).

An example of a linear propoxylated bisphenol A fumarate resin which may be utilized as a resin is available under the trade name SPAMII from Resana S/A Industrias Quimicas, Sao Paulo Brazil. Other propoxylated bisphenol A fumarate resins that may be utilized and are commercially available include GTUF and FPESL-2 from Kao Corporation, Japan, and EM181635 from Reichhold, Research Triangle Park, N.C., and the like.

An amorphous resin or combination of amorphous resins may be present, for example, in an amount of from 45 weight % to 95 weight % by weight of the toner, from 55 weight % to 90 weight % by weight of the toner, or from 65 weight % to 85 weight % by weight of the toner.

The amorphous resin or combination of amorphous resins may have a glass transition temperature of from about 30° C. to about 80° C., from about 35° C. to about 70° C., or from about 40° C. to about 65° C. The glass transition temperature may be measured using differential scanning calorimetry (DSC). The amorphous resin may have a Mₙ, as measured by GPC of, for example, from about 1,000 to about 50,000, from about 2,000 to about 25,000, or from about 1,000 to about 10,000, and a M_{w} of, for example, from about 2,000 to about 100,000, from about 5,000 to about 90,000, from about 10,000 to about 90,000, from about 10,000 to about 30,000, or from about 70,000 to about 100,000, as determined by GPC.

One, two, or more resins may be used to form the toner particles. Where two or more resins are used, the resins may be in any suitable ratio (e.g., weight ratio) such as for instance of from 1% (first resin)/99% (second resin) to 99% (first resin)/1% (second resin), from 10% (first resin)/90% (second resin) to 90% (first resin)/10% (second resin). Where the resins include a combination of amorphous and crystalline resins, the resins may be in a weight ratio of, for example, from 85 weight % to 75 weight % of the amorphous resin and from 5 weight % to 10 weight % of the crystalline resin. In such embodiments, the amorphous resin may be a combination of amorphous resins, e.g., a combination of two amorphous resins.

The resin(s) in the present toners may possess acid groups which may be present at the terminal of the resin. Acid groups which may be present include carboxylic acid groups, and the like. The number of carboxylic acid groups may be controlled by adjusting the materials utilized to form the resin and reaction conditions. In embodiments, the resin is a polyester resin having an acid number from about 2 mg KOH/g of resin to about 200 mg KOH/g of resin, from about 5 mg KOH/g of resin to about 50 mg KOH/g of resin, or from about 5 mg KOH/g of resin to about 15 mg KOH/g of resin. The acid containing resin may be dissolved in tetrahydrofuran solution. The acid number may be detected by titration with KOH/methanol solution containing phenolphthalein as the indicator. The acid number may then be calculated based on the equivalent amount of KOH/methanol required to neutralize all the acid groups on the resin identified as the end point of the titration.

Wax

Optionally, a wax may be included in the present toners. However, in embodiments, no wax is included. When wax is included, a single type of wax or a mixture of two or more different waxes may be used. A single wax may be added, for example, to improve particular toner properties, such as toner particle shape, presence and amount of wax on the toner particle surface, charging and/or fusing characteristics, gloss, stripping, offset properties, and the like. Alternatively, a combination of waxes can be added to provide multiple properties to the toner.

When included, the wax may be present in an amount of, for example, from 0 weight % to 25 weight % by weight of the toner or from 5 weight % to 20 weight % by weight of the toner.

When a wax is used, the wax may include any of the various waxes conventionally used in emulsion aggregation toners. Waxes that may be selected include waxes having, for example, an average molecular weight of from about 500 to about 20,000 or from about 1,000 to about 10,000. Waxes that may be used include, for example, polyolefins such as polyethylene including linear polyethylene waxes and branched polyethylene waxes, polypropylene including linear polypropylene waxes and branched polypropylene waxes, polymethylene waxes, polyethylene/amide, polyethylenetetrafluoroethylene, polyethylenetetrafluoroethylene/amide, and polybutene waxes such as commercially available from Allied Chemical and Petrolite Corporation, for example POLYWAX™ polyethylene waxes such as commercially available from Baker Petrolite, wax emulsions available from Michaelman, Inc. and the Daniels Products Company, EPOLENE N15™ commercially available from Eastman Chemical Products, Inc., and VISCOL 550-P™, a low weight average molecular weight polypropylene available from Sanyo Kasei K. K.; plant-based waxes, such as carnauba wax, rice wax, candelilla wax, sumacs wax, and jojoba oil; animal-based waxes, such as beeswax; mineral-based waxes and petroleum-based waxes, such as montan wax, ozokerite, ceresin, paraffin wax, microcrystalline wax such as waxes derived from distillation of crude oil, silicone waxes, mercapto waxes, polyester waxes, urethane waxes; modified polyolefin waxes (such as a carboxylic acid-terminated polyethylene wax or a carboxylic acid-terminated polypropylene wax); Fischer-Tropsch wax; ester waxes obtained from higher fatty acid and higher alcohol, such as stearyl stearate and behenyl behenate; ester waxes obtained from higher fatty acid and monovalent or multivalent lower alcohol, such as butyl stearate, propyl oleate, glyceride monostearate, glyceride distearate, and pentaerythritol tetra behenate; ester waxes obtained from higher fatty acid and multivalent alcohol multimers, such as diethylene glycol monostearate, dipropylene glycol distearate, diglyceryl distearate, and triglyceryl tetrastearate; sorbitan higher fatty acid ester waxes, such as sorbitan monostearate, and cholesterol higher fatty acid ester waxes, such as cholesteryl stearate. Examples of functionalized waxes that may be used include, for example, amines, amides, for example AQUA SUPERSLIP 6550™, SUPERSLIP 6530™ available from Micro Powder Inc., fluorinated waxes, for example POLYFLUO 190™, POLYFLUO 200™, POLYSILK 19™, POLYSILK 14™ available from Micro Powder Inc., mixed fluorinated, amide waxes, such as aliphatic polar amide functionalized waxes; aliphatic waxes consisting of esters of hydroxylated unsaturated fatty acids, for example MICROSPERSION 19™ also available from Micro Powder Inc., imides, esters, quaternary amines, carboxylic acids or acrylic polymer emulsion, for example JONCRYL 74™, 89™, 130™, 537™, and 538™, all available from SC Johnson Wax, and chlorinated polypropylenes and polyethylenes available from Allied Chemical and Petrolite Corporation and SC Johnson wax. Mixtures and combinations of the foregoing waxes may also be used in embodiments. Waxes may be included as, for example, fuser roll release agents. In embodiments, the waxes may be crystalline or non-crystalline.

Colorant

Optionally, a colorant (other than the disclosed phosphorescent pigments) may be included in the present toners. Colorants include, for example, pigments, dyes, mixtures thereof, such as mixtures of dyes, mixtures of pigments, mixtures of dyes and pigments, and the like. The colorant may be present in an amount of, for example, from 0% to 25% by weight of the toner, from 1% to 20% by weight of the toner, or from 2% to 15% by weight of the toner.

Carbon black, which is available in forms, such as furnace black, thermal black, and the like is a suitable colorant. Carbon black may be used with one or more other colorants, such as a cyan colorant.

Examples of cyan pigments include copper tetra(octadecylsulfonamido) phthalocyanine, a copper phthalocyanine colorant listed in the Color Index (CI) as CI 74160, HELIOGEN BLUE L6900™, D6840™, D7080™, D7020™, PYLAM OIL BLUE™, PYLAM OIL YELLOW™ and PIGMENT BLUE I™ available from Paul Uhlich & Co., Inc., CI Pigment Blue (PB), PB 15:3, PB 15:4, an Anthrazine Blue colorant identified as CI 69810, Special Blue X-2137, mixtures thereof, and the like.

Examples of magenta pigments include a diazo dye identified as C.I. 26050, 2,9-dimethyl-substituted quinacridone, an anthraquinone dye identified as C.I. 60710, C.I. Dispersed Red 15, CINQUASIA MAGENTA™ available from E.I. DuPont de Nemours & Co., C.I. Solvent Red 19, Pigment Red (PR) 122, PR 269, PR 185, mixtures thereof, and the like.

Examples of yellow colorants include diarylide yellow 3,3-dichlorobenzidene acetoacetanilide, a monoazo pigment identified in the Color Index as C.I. 12700, C.I. Solvent Yellow 16, a nitrophenyl amine sulfonamide identified in the Color Index as Foron Yellow SE/GLN, LEMON CHROME YELLOW DCC 1026™ CI, NOVAPERM YELLOW FGL™ from sanofi, Paliogen Yellow 152, 1560 (BASF), Lithol Fast Yellow 0991K (BASF), Paliotol Yellow 1840 (BASF), Neopen Yellow (BASF), Novoperm Yellow FG 1 (sanofi), Permanent Yellow YE 0305 (Paul Uhlich), Pigment Yellow 74, Lumogen Yellow D0790 (BASF), Sunsperse Yellow YHD 6001 (Sun Chemicals), SUCD-Yellow D1355 (BASF), Permanent Yellow FGL, Disperse Yellow, 3,2,5-dimethoxy-4-sulfonanilide phenylazo-4′-chloro-2,5-dimethoxy acetoacetanilide, mixtures thereof, and the like.

Toner Preparation Process

In order to form the present toners, any of the resins described above may be provided as an emulsion(s), e.g., by using a solvent-based phase inversion emulsification process. The emulsions may then be utilized as the raw materials to form the toners by an emulsion aggregation and coalescence (EA) process.

In order to achieve incorporation of the phosphorescent pigments into the toner particles as described above (i.e., phosphorescent pigment embedded within and surrounded by polymeric resin), a separate emulsion comprising the phosphorescent pigment and a surfactant are generally used in the toner preparation process. This may be an aqueous emulsion also comprising water. The phosphorescent pigment emulsion is generally free of any resin. The inventors have determined that certain surfactants are particularly useful to achieve incorporation. Illustrative such surfactants include anionic surfactants such as sodium dodecyl benzene sulfonate, calcium dodecyl benzene sulfonate, and dodecyl benzene sulfonic acid. In embodiments, the surfactants include sodium dodecyl benzene sulfonate, calcium dodecyl benzene sulfonate, and combinations thereof. Combinations of different types of surfactants may be used.

The inventors have further determined certain weight ratios of surfactant to phosphorescent pigment in the emulsion are also particularly useful for achieving incorporation. In embodiments, the weight ratio of surfactant to phosphorescent pigment may be in a range of from 0.05:1 to 0.10:1. This includes from 0.06:1 to 0.09:1, from 0.07:1 to 0.08:1.

The inventors have further determined that homogenization, particularly at high speeds, is particularly useful for achieving incorporation. The phosphorescent pigment emulsion may be homogenized at speeds in a range of from 4000 to 6400 RPM.

Without wishing to be bound to a particular theory, it is thought that the disclosed surfactants at the disclosed amounts using homogenization achieve incorporation, in part, by forming a coating on the phosphorescent pigment particles which is sufficient to maintain a homogeneous distribution of the particles in the emulsions during the toner preparation process further described below. As a result, the toner particles formed may comprise an amount of the surfactant used during the process. In embodiments, the toner particles comprise surfactant at an amount of from 0.5 mg/g to 5 mg/g. from 1 mg/g to 3 mg/g, or 2 mg/g. In embodiments, this surfactant is present as a coating on the embedded phosphorescent pigment particles of the toner particles. The coating can be, but need not completely surround the embedded phosphorescent pigment particles, i.e., it may be a partial coating. Liquid chromatography/mass spectrometry may be used to confirm the amount/presence of surfactant.

If a wax and/or a colorant is used, they may be incorporated into the toner as separate emulsions.

The present toners are prepared by EA processes, such as by a process that includes forming the phosphorescent pigment emulsion as described above; homogenizing a mixture of a resin emulsion comprising a resin; the phosphorescent pigment emulsion; and optionally, one or more of a wax and a colorant; aggregating the mixture; and then coalescing the mixture. The resin emulsion may comprise one or more resins or different resins may be provided as different emulsions. As described above, the wax/colorant may be provided to the mixture as a separate emulsion(s). In forming the mixture to be homogenized, the phosphorescent pigment emulsion may be used in an amount in a range of from 12 weight % to 18 weight %, from 13 weight % to 17 weight %, or 15 weight %, all as compared to the total weight of the mixture. It has been found that incorporation and aggregation are very sensitive to both the amount of surfactant in the phosphorescent pigment emulsion and the amount of the phosphorescent pigment emulsion being used. Outside the ranges disclosed above, the phosphorescent pigments may fail to become incorporated and aggregation may be disrupted.

Homogenization may be carried out using a homogenizer such as an IKA ULTRA TURRAX T50 probe homogenizer. In embodiments, the mixture is homogenized at a speed in a range of from 1,000 to 7,000 revolutions per minute (RPM). During homogenization, an aggregating agent may be added to the mixture. Suitable aggregating agents include, for example, aqueous solutions of a divalent cation or a multivalent cation material. The aggregating agent may be, for example, an inorganic cationic aggregating agent such as a polyaluminum halide such as polyaluminum chloride (PAC), or the corresponding bromide, fluoride, or iodide; a polyaluminum silicate such as polyaluminum sulfosilicate (PASS); or a water soluble metal salt including aluminum chloride, aluminum nitrite, aluminum sulfate, potassium aluminum sulfate, calcium acetate, calcium chloride, calcium nitrite, calcium oxylate, calcium sulfate, magnesium acetate, magnesium nitrate, magnesium sulfate, zinc acetate, zinc nitrate, zinc sulfate, zinc chloride, zinc bromide, magnesium bromide, copper chloride, and copper sulfate; or combinations thereof. The aggregating agent may be added to the mixture at a temperature that is below the glass transition temperature (T_{g}) of the resin(s).

The aggregating agent may be added to the mixture in an amount of, for example, from 0 weight % to 10 weight % by weight of the total amount of resin, from 0.2 weight % to 8 weight % by weight of the total amount of resin, or from 0.5 weight % to 5 weight % by weight of the total amount of resin.

Aggregation may be initiated and carried out under heating, e.g., by maintaining an elevated temperature, or slowly raising the temperature to, for example, from 30° C. to 100° C., from 30° C. to 80° C., or from 30° C. to 50° C. The temperature may be held for a period time of from 0.5 hours to 6 hours, from 1 hour to 5 hours. Aggregation is carried out while agitating the mixture. In order to achieve incorporation of the phosphorescent pigment particles as described above, the inventors have further determined that certain speeds are particularly useful for agitation. These speeds are higher than used in the aggregation step of existing EA processes and include at least 450 RPM, at least 500 RPM, at least 550 RPM, or in a range of from 450 to 600 RPM.

The particles of the mixture are permitted to aggregate until a predetermined desired particle size is obtained. A predetermined desired size refers to the desired particle size to be obtained as determined prior to formation, and the particle size being monitored during the growth process until such particle size is reached. Samples may be taken during the growth process and analyzed, for example with a Coulter Counter, for volume or number average particle size. Once the predetermined desired particle size is reached, a shell may be added. The volume average particle size of the particles prior to application of a shell may be, for example, from 3 μm to 10 μm, from 4 μm to 9 μm, or from 5 μm to 8 μm.

Shell Resin

After aggregation, but prior to coalescence, a resin coating may be applied to the aggregated particles to form a shell thereover. Any of the resins described above may be utilized in the shell. In embodiments, an amorphous polyester resin is utilized in the shell. In embodiments, two amorphous polyester resins are utilized in the shell. In embodiments, a crystalline polyester resin and two different types of amorphous polyester resins are utilized in the core and the same two types of amorphous polyester resins are utilized in the shell.

The shell may be applied to the aggregated particles by using the shell resins in the form of emulsion(s) as described above. Such emulsions may be combined with the aggregated particles under conditions sufficient to form a coating over the aggregated particles. For example, the formation of the shell over the aggregated particles may occur under heating as described above. The formation of the shell may take place for a period of time from 10 minutes to 5 hours or from 20 minutes to 3 hours.

Once the desired size of the toner particles is achieved, the pH of the mixture may be adjusted with a pH control agent, e.g., a base, to a value of, e.g., from 3 to 10 or 5 to 9. The adjustment of the pH may be utilized to freeze, that is to stop, growth of particles. Any suitable base may be used, such as alkali metal hydroxides, such as sodium hydroxide, potassium hydroxide, ammonium hydroxide, combinations thereof, and the like. In embodiments, a chelating agent such as ethylenediaminetetraacetic acid (EDTA) may be added to help adjust the pH to the desired values noted above. Other chelating agents may be used.

In embodiments, the size of the core-shell toner particles (prior to coalescence) may be from 4 μm to 10 μm, from 5 μm to 10 μm, or from 6 μm to 9 μm.

Coalescence

Following aggregation to the desired particle size and optional application of the shell, the particles may then be coalesced to the desired final shape, the coalescence being achieved by, for example, heating the mixture to a temperature of from 45° C. to 150° C., from 55° C. to 100° C., or 60° C. to 90° C., which may be at or above the glass transition temperature of the resins utilized to form the toner particles. Heating may continue or the pH of the mixture may be adjusted (e.g., reduced) over a period of time to reach the desired circularity. The period of time may be from 1 hours to 5 hours or from 2 hours to 4 hours. Various buffers may be used during coalescence. The total time period for coalescence may be from 1 hour to 9 hours, from 1 hour to 8 hours, or from 1 hour to 5 hours.

After aggregation and/or coalescence, the mixture may be cooled to room temperature. The cooling may be rapid or slow, as desired. A suitable cooling process may include introducing cold water to a jacket around the reactor. After cooling, the toner particles may be screened with a sieve of a desired size, filtered, washed with water, and then dried. Drying may be accomplished by any suitable process for drying including, for example, freeze-drying.

Other Additives

The present toners may also contain other optional additives. For example, the toners may include positive or negative charge control agents. Surface additives may also be used. Examples of surface additives include metal oxides such as titanium oxide, silicon oxide, aluminum oxides, cerium oxides, tin oxide, mixtures thereof, and the like; colloidal and amorphous silicas, such as AEROSIL®, metal salts and metal salts of fatty acids such as zinc stearate, calcium stearate, and magnesium stearate, mixtures thereof and the like; long chain alcohols such as UNILIN 700; and mixtures thereof. Each of these surface additives may be present in an amount of from 0.1 weight % to 5 weight % by weight of the toner or from 0.25 weight % by weight to 3 weight % by weight of the toner.

Toner Properties

In embodiments, the dry toner particles, exclusive of external surface additives, exhibit one or more of the following characteristics:

(1) Volume average particle size of from 5.0 μm to 10.0 μm, from 6.0 μm to 10.0 μm, or from 7.0 μm to 9.0 μm.

(2) Volume average geometric size distribution (GSDv) of from 1.100 to 1.300, from 1.175 to 1.275, from 1.180 to 1.260 and a number average geometric size distribution (GSDn) of from 1.100 to 1.300, from 1.175 to 1.275, from 1.180 to 1.260.

(3) Circularity of from 0.950 to 1.000, from 0.950 to 0.990, or from 0.955 to 0.965.

It is noted that other methods for forming toner particles, such as the physical toner preparation processes of melt blending/mixing/kneading, extrusion, powder coating, etc. are not capable of forming toner particles having the sizes, distribution and circularity disclosed above.

These characteristics may be measured according to the techniques described in the Example, below.

Developers and Carriers

The present toners may be formulated into a developer composition. Developer compositions can be prepared by mixing the toners of the present disclosure with known carrier particles, including coated carriers, such as steel, ferrites, and the like. Such carriers include those disclosed in U.S. Pat. Nos. 4,937,166 and 4,935,326, the entire disclosures of each of which are incorporated herein by reference. The toners may be present in the carrier in amounts of from 1 weight % to 15 weight % by weight, from 2 weight % to 8 weight % by weight, or from 4 weight % to 6 weight % by weight. The carrier particles can also include a core with a polymer coating thereover, such as polymethylmethacrylate (PMMA), having dispersed therein a conductive component like conductive carbon black. Carrier coatings include silicone resins such as methyl silsesquioxanes, fluoropolymers such as polyvinylidiene fluoride, mixtures of resins not in close proximity in the triboelectric series such as polyvinylidiene fluoride and acrylics, thermosetting resins such as acrylics, mixtures thereof and other known components.

Applications

The present toners may be used in a variety of xerographic processes and with a variety of xerographic printers. A xerographic imaging process includes, for example, preparing an image with a xerographic printer comprising a charging component, an imaging component, a photoconductive component, a developing component, a transfer component, and a fusing component. In embodiments, the development component may include a developer prepared by mixing a carrier with any of the toners described herein. The xerographic printer may be a high-speed printer, a black and white high-speed printer, a color printer, and the like. Once the image is formed with the toners/developers, the image may then be transferred to an image receiving medium such as paper and the like. Fuser roll members may be used to fuse the toner to the image-receiving medium by using heat and pressure.

### EXAMPLE

The following Example is being submitted to illustrate various embodiments of the present disclosure. The Example is intended to be illustrative only and is not intended to limit the scope of the present disclosure. Also, parts and percentages are by weight unless otherwise indicated. As used throughout this disclosure, “room temperature” refers to a temperature of from 20° C. to 25° C.

Toner Preparation. A phosphorescent pigment emulsion was prepared by adding phosphorescent pigment (G9-510-S green phosphorescent pigments from Allureglow USA) to a solution of deionized water and surfactant (Taycapower BN2070N) at a surfactant:pigment weight ratio of 5 pph. The phosphorescent pigment emulsion was homogenized at 6400 RPM for one hour. A resin emulsion was prepared by combining 175 g of a first type of an amorphous polyester resin, 175 g of a second type of an amorphous polyester resin, and 61 g of a crystalline polyester resin. The phosphorescent pigment emulsion was slowly added to the resin emulsion while homogenizing. The homogenization conditions were as follows 6400 RPM, 30 minutes. This mixture was acidified and an aluminum sulfate solution was added during homogenization. After homogenization, the mixture was transferred to a 2 L reactor. The reactor was heated to 48° C. and stirred vigorously (agitation at 550 RPM) to initiate aggregation. Once the particle size reached about 7.50 μm, an emulsion containing the two amorphous polyester resins was added to the mixture to form a shell over the particles and the particles were allowed to continue grow. The particles were allowed to grow to 8.55 μm, at which point aggregation was stopped by addition of a chelating agent (EDTA) and raising the pH to 7.8 with sodium hydroxide. The reactor temperature was increased to 84° C. to allow the particles to coalesce. When the particle circularity reached 0.960±0.002, the mixture was run through a heat exchanger for quenching. The mixture was placed over a 20 μm sieve and filtered under vacuum. The resulting wet-cake was washed with deionized water and freeze dried.

A standard iGen external additive package was used for toner blending. The dry mixture of the phosphorescent toner particles and additives was blended at 12,500 rpm for 60 seconds in a benchtop Fuji mill. The phosphorescent toner particles had 15 weight % phosphorescent pigment; 85 weight % resin; and external additives including 3.5 weight % NA50HS, 1.6 weight % SMT5103; 0.35 weight % ZnSTL; and 0.1 weight % H2O50.

Toner Characterization. Toner particle size was analyzed from dry phosphorescent toner particles, exclusive of external surface additives, using a Beckman Coulter Multisizer 3 operated in accordance with the manufacturer's instructions. Representative sampling occurred as follows: a small amount of toner sample, about 1 gram, was obtained and filtered through a 25 μm screen, then put in isotonic solution to obtain a concentration of about 10%, with the sample then run in the multisizer. The D50v size for the phosphorescent toner particles was 8.55 μm. The volume average geometric size distribution (GSDv) was 1.254. The number average geometric size distribution (GSDn) was 1.193.

Circularity was analyzed from dry phosphorescent toner particles, exclusive of external surface additives, using a Sysmex 3000 operated in accordance with the manufacturer's instructions. As noted above, the circularity of the phosphorescent toner particles was 0.960±0.002.

Phosphorescent toner particle morphology was analyzed from dry toner particles, exclusive of external surface additives, by scanning electron microscopy (SEM). The images of the phosphorescent toner particles (data not shown) clearly showed that the particles were highly circular and uniform in size and shape. The images also showed that the phosphorescent pigments were embedded within and surrounded by resin, with on average, a single phosphorescent pigment particle per toner particle.

The phosphorescent properties of the phosphorescent toner particles were confirmed by illuminating the particles with ultraviolet (UV) light for 30 seconds. After illumination, both bulk phosphorescent toner particles and wet deposition particles glowed bright green in the dark.

The word “illustrative” is used herein to mean serving as an example, instance, or illustration. Any aspect or design described herein as “illustrative” is not necessarily to be construed as preferred or advantageous over other aspects or designs. Further, for the purposes of this disclosure and unless otherwise specified, “a” or “an” means “one or more.”

It will be appreciated that variants of the above-disclosed and other features and functions or alternatives thereof, may be combined into many other different systems or applications. Various presently unforeseen or unanticipated alternatives, modifications, variations or improvements therein may be subsequently made by those skilled in the art, which are also intended to be encompassed by the following claims.

What is claimed is:

1. A method of making a phosphorescent toner, the method comprising:
forming a phosphorescent pigment emulsion comprising a phosphorescent pigment and a surfactant;
homogenizing a mixture comprising a resin emulsion comprising a resin and the phosphorescent pigment emulsion;
aggregating the mixture to form toner particles comprising the phosphorescent pigment embedded within and surrounded by the resin; and
coalescing the toner particles to form a phosphorescent toner comprising the toner particles.

2. The method of claim 1, wherein the surfactant is selected from sodium dodecyl benzene sulfonate, calcium dodecyl benzene sulfonate, and combinations thereof.

3. The method of claim 1, wherein the phosphorescent pigment emulsion has a weight ratio of the surfactant to the phosphorescent pigment in a range of from 0.05:1 to 0.10:1.

4. The method of claim 1, wherein the step of forming the phosphorescent pigment emulsion comprises homogenizing the phosphorescent pigment emulsion.

5. The method of claim 1, wherein the phosphorescent pigment emulsion is present in the mixture at an amount in a range of from 12 weight % to 18 weight %.

6. The method of claim 1, wherein the mixture is agitated during the step of aggregating at a speed of at least 450 revolutions per minute.

7. The method of claim 1, wherein the surfactant is selected from sodium dodecyl benzene sulfonate, calcium dodecyl benzene sulfonate, and combinations thereof; the phosphorescent pigment emulsion has a weight ratio of the surfactant to the phosphorescent pigment in a range of from 0.05:1 to 0.10:1; the step of forming the phosphorescent pigment emulsion comprises homogenizing the phosphorescent pigment emulsion; the phosphorescent pigment emulsion is present in the mixture at an amount in a range of from 12 weight % to 18 weight %; and the mixture is agitated during the step of aggregating at a speed of at least 450 revolutions per minute.

8. The method of claim 1, wherein the phosphorescent pigment is a lanthanide doped alkaline earth metal aluminate.

9. The method of claim 1, wherein the resin emulsion comprises a first type of amorphous polyester resin, a second type of amorphous polyester resin, and a crystalline polyester resin.

10. The method of claim 9, wherein the first type of amorphous polyester resin is a poly(propoxylated bisphenol-co-terephthlate-fumarate-dodecenylsuccinate), the second type of amorphous polyester resin is a poly(propoxylated-ethoxylated bisphenol-co-terephthalate-dodecenylsuccinate-trimellitic anhydride), and the crystalline polyester resin is a poly(1,6-hexylene-1,12-dodecanoate).

11. The method of claim 1, wherein the toner particles have a volume average particle size of 5.0 μm to 10.0 μm, a volume average geometric size distribution (GSDv) of from 1.100 to 1.300, and a number average geometric size distribution (GSDn) of from 1.100 to 1.300.

12. The method of claim 1, wherein the toner particles have a circularity of from 0.950 to 1.000.

13. The method of claim 1, wherein the toner particles have an average phosphorescent pigment particle to toner particle ratio of 1.

14. The method of claim 1, wherein the toner particles comprise the surfactant at an amount in a range of from 0.5 mg/g to 5 mg/g.

15. The method of claim 1, wherein the phosphorescent pigment in the toner particles has a coating of the surfactant surrounding the phosphorescent pigment.

16. The method of claim 15, wherein the toner particles comprise the surfactant at an amount in a range of from 0.5 mg/g to 5 mg/g.

17. The method of claim 1, wherein the toner particles have a volume average particle size of 5.0 μm to 10.0 μm, a GSDv of from 1.100 to 1.300, and a GSDn of from 1.100 to 1.300; a circularity of from 0.950 to 1.000; an average phosphorescent pigment particle to toner particle ratio of 1; and the phosphorescent pigment in the toner particles has a coating of the surfactant surrounding the phosphorescent pigment.

18. The method of claim 1, wherein the phosphorescent pigment embedded within and surrounded by the resin forms a core of the toner particles and the method further comprises forming a resin shell over the core to form core-shell toner particles.

19. A phosphorescent toner comprising toner particles comprising a core comprising a phosphorescent pigment embedded within and surrounded by a resin, wherein the toner particles have a volume average particle size of 5.0 μm to 10.0 μm, a volume average geometric size distribution (GSDv) of from 1.100 to 1.300, and a number average geometric size distribution (GSDn) of from 1.100 to 1.300.

20. A method of using the phosphorescent toner of claim 19, the method comprising:
forming an image comprising the phosphorescent toner using a xerographic printer;
transferring the image comprising the phosphorescent toner to an image receiving medium; and
fusing the phosphorescent toner to the image receiving medium.
